(19) United States
(12) Patent Application Publication
(10) Pub. No.: US 2018/0356960 A1
(43) Pub. Date: Dec. 13, 2018

(54) ACTIONABLE IMAGE REPRESENTATION OF VIDEO PROJECT IN A VIDEO CREATION SYSTEM

(71) Applicant: Google Inc., Mountain View, CA (US)

(72) Inventor: Molly Castle Nix, San Francisco, CA (US)

(73) Assignee: Google Inc., Mountain View, CA (US)

(21) Appl. No.: 14/221,041

(22) Filed: Mar. 20, 2014

Related U.S. Application Data
(60) Provisional application No. 61/899,072, filed on Nov. 1, 2013.

(51) Int. Cl. G06F 3/0484

(52) U.S. Cl. CPC G06F 3/04842

(57) ABSTRACT

A media item project generation system for generating a composite media item, is disclosed herein. The media item project generation system can capture multiple media items and generate a new media item as a composite of the multiple media items. A content creator can capture a media item and display a representation of the media item while in a recording mode for capturing another media item. The representation can comprise an actionable graphical representation of the media item.

### CROSS-REFERENCE TO RELATED APPLICATIONS

This application claims the benefit of U.S. Provisional Application No. 61/899,072, filed Nov. 1, 2013 and entitled “ACTIONABLE IMAGE REPRESENTATION OF INCOMPLETE VIDEO PROJECT IN MOBILE VIDEO CREATION,” the entirety of which is incorporated herein by reference.

### TECHNICAL FIELD

This disclosure generally relates to media capturing methods and systems including a multiple item media project.

### BACKGROUND

Media capture systems are used to capture still images, video, and audio. These systems are increasingly available to users through a number of devices. The proliferation, advancement, and affordability of media capturing devices such as smart phones, digital cameras, and other electronic devices has made media capturing easier and more available to the general public than ever before. Sharing of videos captured by individuals attending a particular sporting event, wedding, music concert or birthday party, etc. by way of a social media website has become commonplace.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its purpose is to present some concepts of the specification in a simplified form as a prelude to the more detailed description that is presented in this disclosure.

Systems disclosed herein relate to capturing media items and providing a representation of a current project while in a recording mode. A user can utilize a media capturing device to capture a video. The video can be added to a project and a representation of the project, such as a thumbnail, can be displayed on a recording screen. The representation can be selected to advance or navigate the media project generation process.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates a block diagram of an example system that can facilitate generating a multi-item media project and a visual representation of the media project within a recording screen, in accordance with certain embodiments of this disclosure;

FIG. 2 is an illustration of an exemplary display record screen in accordance with certain embodiments of this disclosure;

FIG. 3 illustrates a diagram of an example system that can facilitate generating a multi-item media project and a visual representation of the media project within a recording screen including altering screens, in accordance with certain embodiments of this disclosure;

FIG. 4 illustrates an example methodology that can provide for generating a visual representation of a media project during project generation, according to an aspect of this disclosure;

FIG. 5 illustrates an example methodology that can provide for generating a visual representation of a media project during project generation, according to an aspect of this disclosure;

FIG. 6 illustrates an example methodology that can provide for generating a visual representation of a media project during project generation including removing at least a portion of the visual representation during an active recording mode, according to an aspect of this disclosure;

FIG. 7 illustrates an example methodology that can provide for generating a visual representation of a media project during project generation including rendering an editing screen in an editing mode, according to an aspect of this disclosure;

FIG. 8 illustrates an example methodology that can provide for generating a visual representation of a media project during project generation including updating at least a portion of the visual representation during a recording mode, according to an aspect of this disclosure;

FIG. 9 illustrates an example schematic block diagram for a computing environment in accordance with certain embodiments of this disclosure; and

FIG. 10 illustrates an example block diagram of a computer operable to execute certain embodiments of this disclosure.

### DETAILED DESCRIPTION

Various aspects or features of this disclosure are described with reference to the drawings, wherein like reference numerals are used to refer to like elements throughout. In this specification, numerous specific details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing this disclosure.

It is to be appreciated that in accordance with one or more implementations described in this disclosure, users can opt-out of providing personal information, demographic information, location information, proprietary information, sensitive information, machine information, or the like in connection with data gathering aspects. Moreover, one or more implementations described herein can provide for anonymizing collected, received, or transmitted data.

In an embodiment, a media item can be captured or otherwise comprised in a media recording system. A container component can store the media item in a project. A recording component can present a recording screen that comprises a feed of media to be recorded into a project. In response to the project already having a previous media item, a portal component can display a project visualization element. The project visualization element can comprise data describing the project such as data describing the previous media item or a set of media items (e.g., thumbnail images or media), data describing a length of the project, available actions (e.g., save project, continue to editing, exit program, record, stop recording, etc.) and the like. In another aspect, an editing component can display a set of media items comprised by the project, a timeline, available actions, and data describing the project.

As an example, a user can utilize a smart phone to capture a video during a hiking trip. A media capturing system, employed by the smart phone, can display a record screen in a record mode. After the user captures the video, a record screen can be displayed with a representation of the video. The representation can be a thumbnail image for example. The user can observe the thumbnail to determine contents of a media project without leaving a record screen. In this manner, a user can capture multiple videos for a project with greater ease and efficiency.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other.

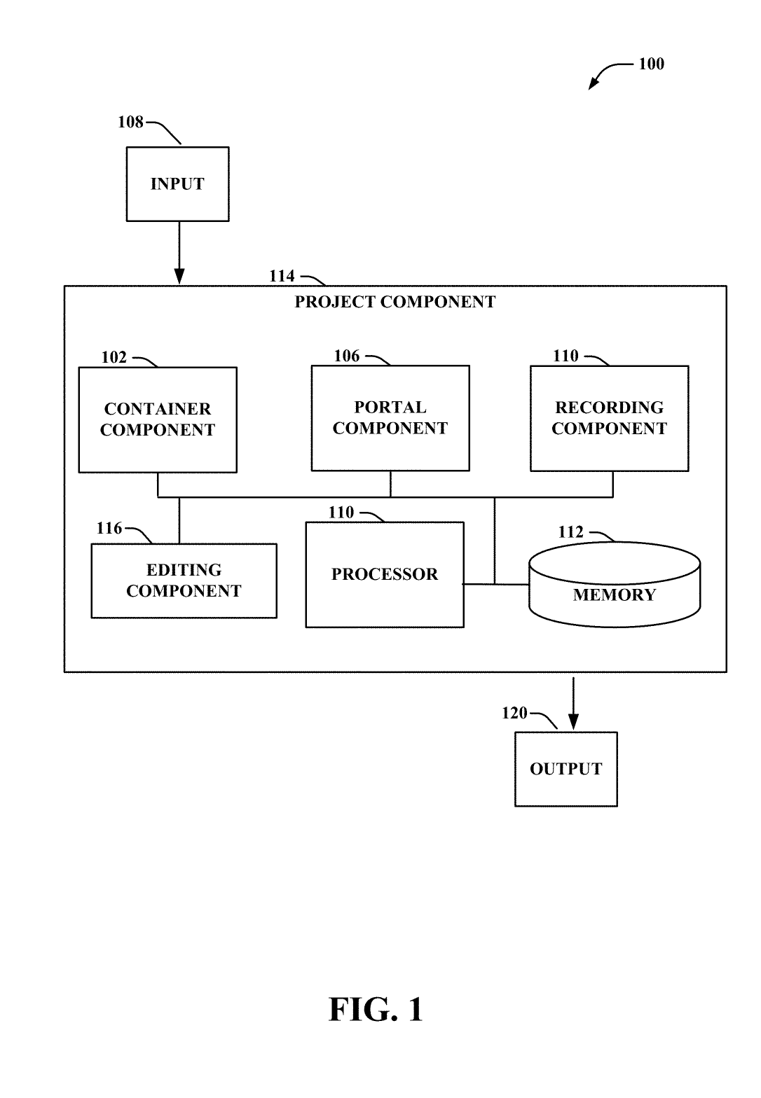

Referring now to FIG. 1, a system 100 is depicted. System 100 can, inter alia, facilitate generating a multi item media project in accordance to various aspects disclosed herein. Embodiments disclosed herein can, for example, provide visual representations of projects on a record screen and actionable options to enable generation and editing of media projects. As depicted, system 100 can include a project component 114 that facilitates managing, creation, and editing of media item projects. Primary components of the project component 114 include memory 112 that stores computer executable components and a processor 110 that executes computer executable components stored in the memory. The memory component 114 can include a container component 102 that comprises projects and their respective media items; a portal component 106 that manages a project visualization element; a recording component 110 that can record and/or capture media items; and an editing component 116 that can facilitate editing of project. In an aspect, project component 114 can be configured to receive input 108. Input 108 can include media (e.g., audio, video, images, and the like), data associated with the media, instructions from another device, and user input, for example. Project component 114 can process the input and generate output 120, such as a published media item project.

Recording component 110 can receive input 108 and generate a computer readable media item based on the input 108. As an example, recording component 110 can receive audio and/or visual information and can convert/save the information as a media item. It is noted that the recording component 110 can include various media capturing components such as microphones and cameras. It is also noted that the recording component 110 can record information in various types of formats or standards, such as moving pixel expert group 1 (MPEG-1), MPEG-2, MPEG-3, MPEG-4, H.264/MPEG-4 AVC, and the like.

Container component 102 can store media items in various containers and/or projects. A project can comprise a set of media items to be published as a single media item (e.g., a continuous media item, a chaptered media item, a serialized media item, etc.). It is understood that storing media items in a container and/or project can refer to storing references to media items or otherwise associating the media items to the container/project. It is noted that the container component 102 can comprise additional data, such as data describing a project (e.g., name, creation date, publication date, status), describing a media item (e.g., name, creator, creation date, etc.), and the like.

As an example, a user can capture (via the recording component 110) a video of the start of hiking trip using a smart phone. The video can be added to a container (via the container component 102) that holds videos for a project, such as a “Hiking Trip” container. The user can capture other videos (via the recording component 110) and the videos can be added to the “Hiking Trip” container.

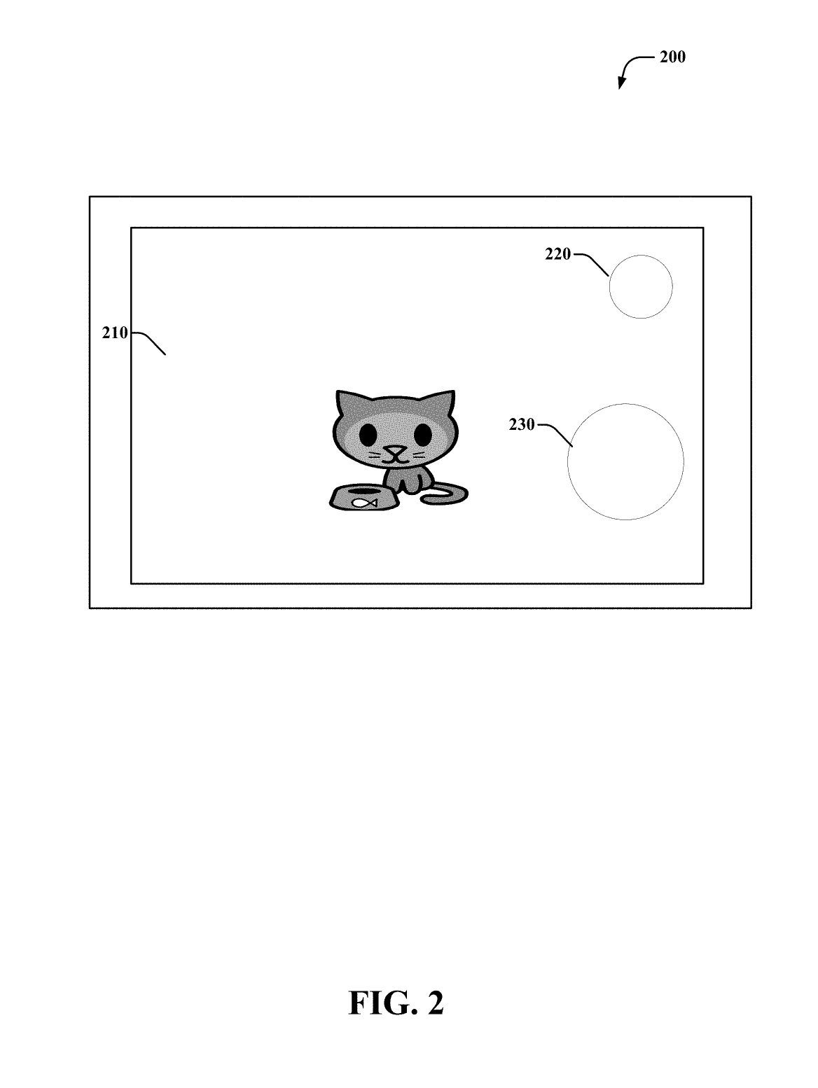

In another aspect, recording component 110 can initiate rendering of a record screen. For example, with reference to FIG. 2, there illustrated is an example system 200 that primarily comprises a record screen 210, a project visualization element 220, and a recording actuation element 230. In an implementation, recording component 110 can initiate rendering of the record screen 210. The record screen 210 can comprise media to be capture. For example, a camera (not shown) can receive visual information and the recording component 110 can render the record screen with a representation of the information in a select format. In another aspect, the recording component 110 can, while in a record mode, render the recording actuator element 230 that, in response to input, initiates capturing of media.

In another aspect, the portal component 106 can initiate rendering of the project visualization element 220. The project visualization element 220 can comprise data describing a current project and available actions for the current project. For example, the portal component 106 can determine whether a current project comprises one or more media items. In response to determining the current project comprises one or more media items, the portal component 106 can render the project visualization element 220 including data describing the current project and/or available actions.

Continuing with the above example, the project visualization element 220 can comprise a clip, image, and/or series of images already contained in the Hiking Trip component. While the user is in a record mode for the Hiking Trip, the user can view the media content contained in the Hiking Trip. If the user selects to enter an active record mode (e.g., capture a new media item), then a recording process can be actuated. In implementations, the project visualization element 220 can be hidden (e.g., not rendered) during active recording thereby allowing for greater visibility of the media being captured. However, in other implementations the project visualization element 220 can be rendered during the active recording. It is noted that a user can select whether the project visualization element 220 is rendered during the active record mode, such as through a settings screen.

In an aspect, the portal component 106 can render the representation of the one or more media items in the project visualization element 220. It is noted that the representation can comprise one or more the media items that are comprised in a current project. For example, the portal component 106 can generate the portal component 220 to comprise a representation of a media item most recently captured and/or added to the project. In an aspect, the representation can comprise textual data, an image (e.g., thumbnail, low resolution, reduce size image, etc.), and the like. In another aspect, the representation can comprise a series of images representing the set of media items comprised by the projects. For example, the project visualization element 220 can render a slide show of media comprised in a container. Textual data can be rendered to indicate a relative position of the media (e.g., first media item in the container, second media item in the container, and the like.). It is noted that a user can provide input that can determine what content is rendered in the project visualization element 220, such as through a settings screen.

In implementations, the portal component 106 can render additional data associated with the project and available actions in the project visualization element 220. For example, the portal component 106 can determine a length of time associated with the project and can display the time in the project visualization element 220. The available actions can include, for example, exit the recording mode, exit a recording program, continue to an editing screen, save a project, finalize a project, delete a media item, etc. As above, a user can provide input and to indicate a users preference on the amount and type of data rendered in the project visualization element 220.

In an aspect, a user can provide input to begin recording a new media item (e.g., via the recording actuation element 230). In response to the input, the recording component 110 can render an active recording screen. In an aspect, the active recording screen can display media that is simultaneously and/or substantially simultaneously being captured. It is noted that there may be a delay in capturing and displaying the media. In another aspect, in response to initiating the capturing the portal component 106 can hide and/or end rendering of the project visualization element 220 and/or a portion of the project visualization element 220. In another aspect, the recording component 110 can alter the recording actuation element 230 to an active recording element as described in more detail below.

The editing component 116 can render an editing screen for managing and/or editing a project. In an aspect, the editing component 116 can render a timeline, representations of individual media items of a project, provide a preview of a project, and provide available actions (add audio, adjust media item, reorder media items, delete media item, add more media items, finalize project, save project, exit project, etc.). In another aspect, the editing component 116 can receive information representing instructions on editing the project. For example, a user can provide information to select a media item and alter a length of the media item, brighten a media item, etc.

In another aspect, the user can provide input indicate the user wants to replace a media item of the project. The editing component 116 can receive the input and system 100 can enter a replacement mode. The recording component 110 can render the recording screen and/or an active recording screen. In another aspect, the portal component 106 can render a project visualization that indicates the media item being replaced such as through text, images, graphics, and the like.

Continuing with the Hiking Trip example above, the editing component 116 can render an editing screen comprising media items and/or representations of the media items. The representations can comprise thumbnail images, snippets of media item (e.g., one frame, a series of frames, video, etc,). The user can provide input representing a desired action to the editing component 116 (e.g., through an interface such as a touch screen). For example, the user can provide input to actuate finalizing of a project (e.g., aggregating the media items into a new media item), publishing a project (e.g., uploading, sending, etc.), editing a project (e.g., add/remove media items, frames of media items, etc.), saving/deleting a project, or otherwise altering the project.

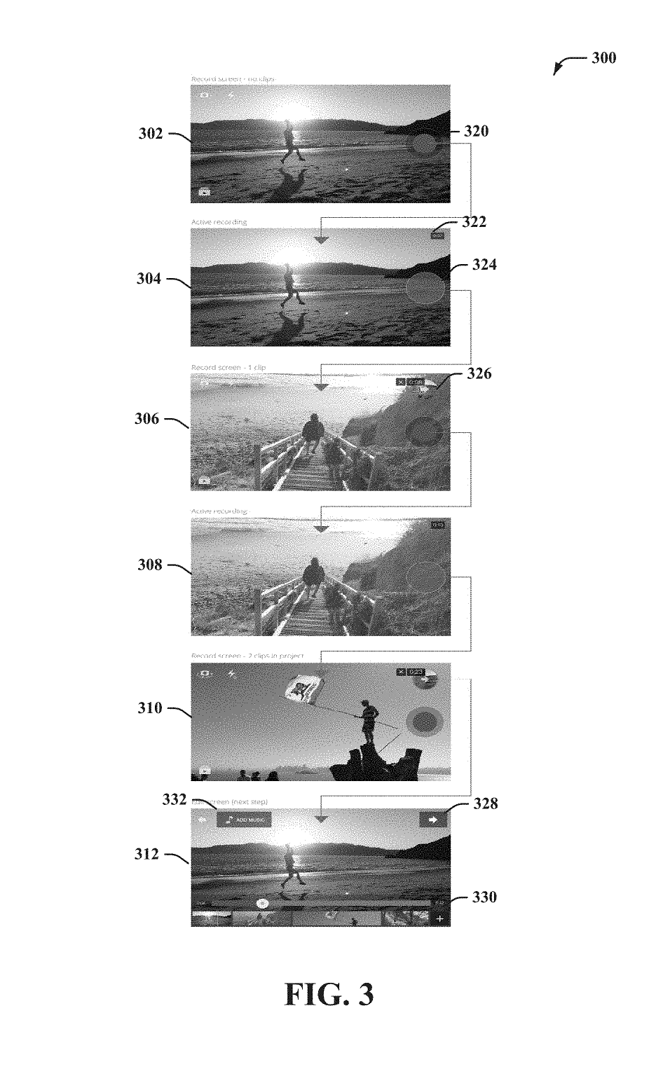

Turing now to FIG. 3, with reference to FIG. 1 and FIG. 2, there illustrated is a system 300 that facilitates generating a multi item media project in accordance to various aspects disclosed herein. Embodiments disclosed herein can, for example, provide visual representations of projects on a record screen and actionable options to enable generation and editing of media projects. In an aspect, system 300 can primarily include recording screens 302, 306, and 310 that represent a rendered screen during a recording mode; active recording screens 304, and 308 that that represent a rendered screen during an active recording mode; and an editing screen 312 that represents a rendered screen during an editing mode. In an aspect, the system 300 can comprise and/or utilize various component of system 100. For example, the recording component 110 can render recording screen 302.

In an implementation, the recording component 110 can render various screens based on data describing a current project, available actions, and user input. For example, the recording component 110 can determine, in response to information received from the container component 102, whether a project contains a media item. If the project does not contain a media item (e.g., empty project), the recording component 110 (while in a record mode) can generate the recording screen 302. It is noted that the recording screen 302 does not contain a rendering of a project visualization element. In another aspect, the recording screen 302 can comprise a rendering of available options, such as exit project, actuate recording, change camera, change picture mode, adjust flash settings, etc.

As depicted, recording screen 302 can comprise a recording actuator 320. The recording actuator 320 can, in response to input, actuate recording of media and entering of an active recording mode. While shown as a circle, it is noted that the recording actuator 320 can be of various shapes and sizes as well as in various locations on the recording screen 302. In another aspect, the recording actuator 320 can comprise a depressible actuator (e.g., a button on a smart phone, camera, and the like) that is not rendered on the recording screen. In another aspect, the recording actuator 320 can comprise one or more actuators such as a recording actuator 320 generate on the recording screen 302 and a recording actuator 320 of a larger device (e.g., record button on a camera, smart phone, or other device).

In an implementation, if the project does contain a media item (e.g., is not empty) the recording component 110 (while in a record mode) can generate the recording screen 306 and/or 310, for example. It is noted that the recording screens 306 (and 310) contain a rendering of a project visualization element 326. The project visualization element 326, as depicted, can comprise an image of a previously capture media item and/or available actions. It is noted that the image of the previously capture media item can also represent an available actions, such that, when selected, the system 300 can enter an editing mode and render editing screen 312.

In an aspect, the project visualization element 326 can comprise a thumbnail or other representation of a media project. It is noted that the thumbnail can comprise an image, a series of images, a video, and the like. As an example, portal component 106 can render a representation of the most recently captured media item of a project, a selected media item of the project based on preference, a title screen, a series of images/videos each representing a disparate media item of the project (e.g., in chronological order for example), and the like. It is noted that, while the project visualization element is depicted in the upper right corner, the project visualization element can be displayed in various positions. It is also noted that a user can select a desired position, a desired media item (e.g., last captured, first of a project, and the like), and other preferences for the project visualization element 326. While the project visualization element 326 is shown as a circular rending, the project visualization element 326 can be various other shapes.

In implementations, the project visualization element 326 can be altered based on user input. In an implementation, the portal component 106 can detect user input representing a “light” press or a “hard” press of the project visualization element 326. A light press can comprise actuating the project visualization element 326 for a determined amount of time (e.g., between zero and one second), a single press, or another pattern of pressing. A hard press can comprise actuating the project visualization element 326 for a different determined amount of time (e.g., pressing and holding between one second and two seconds), a double press (e.g., two presses in a given amount of time), or other pattern of pressing. It is noted that the patterns described above are for example only, as such a light or hard press can correspond to any pressing pattern and any amount of time. Additionally, the portal component 106 can detect any number of actuation types not just a light or hard press.

Each actuation type can correspond to a different action. For example, in response to a light press, the portal component 106 can advance the project to an editing mode, while a hard press can alter the project visualization element 326. Altering the project visualization element can comprise moving the project visualization element 326 (e.g., dragging and dropping the project visualization element 326 to a desired location), altering a display aspect the project visualization element 326 (e.g., resizing, adjusting resolution, adjusting intensity, adjusting opaqueness, and the like), changing the media item rendered by the portal component 106, and the like. In an example, in response to the portal component 106 detecting a hard press, the portal component 106 playback the media item rendered in the project visualization element 326. Playback can comprise playing the media item in the project visualization element 326, playing the media item in a larger portion of the screen, and the like. In another aspect, the portal component 106 can rotate to a different media item comprised in the project by switching the media item represented in the project visualization element. As yet another example, the portal component 106 can expand the project visualization element 326 to display representations of all or a portion of the media items of a project. Displaying the representations can include rendering all or a portion of the media items across the top of the recording screen 306, for example.

In another aspect, the project visualization element can be enabled/disabled according to a user preference through a settings screen, in the recording screen (e.g., based on a type of actuation), and the like. For example, a user can provide input to enable or disable the project visualization element for a certain project, all projects, and the like. It is noted that a system can learn a users preferences and apply the preference to future projects.

In response to initiating a recording, the recording component 110 can render active recording screen 304 and/or 308. While recording screens 304 and 308 are depicted as having a rendering of media being captured, it is appreciated that the recording screens 304 and 308 need not display the media being captured. For example, during an active recording mode, the recording screens 304 and 308 can display a blank screen, available options, and data describing the project and/or media item being captured, and the like. In some implementations, a user can view the media items being captured through a viewfinder (e.g., a lens and/or mirror combination of a smart phone, camera, and the like). It is noted that the recording component 110 can alter a recording actuation element 320 and/or replace the element 320 with an indicator 324 representing a recording taking place. In another aspect, the recording component 110 can render data describing a length of time 322 of the total project and/or a media item that is currently being captured. It is noted that the active recording screens 304, 308 can hide or delete all or a portion of a project visualization element. Hiding or deleting the project visualization element can provide more space for a user to view a media item being captured. However, it is noted that the project visualization element 320 can be rendered during the active recording. In another aspect, a user can provide input to enable displaying the project visualization element in the active recording mode.

In implementations, the project visualization element 320 can be transparent, semi-transparent (e.g., watermark), moved, or otherwise altered based on a user preference, a current mode (e.g., active recording mode, recording mode, etc.) and the like. For example, a user can provide input to move the project visualization element and/or set transparency levels of the project visualization element. In another example, a user can provide input for a preference during a recording mode and an active recording mode.

In an aspect, the indicator 324 can comprise a rendering of a graphic or textual object that indicates active recording on the recording screen 304. The rendering can comprise a flashing, moving, or otherwise indicating object that represents active recording. It is noted that the indicator 324 can provide information such as the amount of space and/or length of video that can be captured. In another aspect, the recording component 110 can detect actuation of the indicator 324 or actuation of another actuator such as a button of a smart phone or camera, a voice command, and the like. In response to detecting the actuation, the recording component 110 can end the active recording process. Ending the active recording process can comprise saving the captured media, terminating the active recording process, entering a recording mode, entering an editing mode, and the like. It is noted that the indicator 324 can be of various shapes, sizes, and/or positions. It is further noted that the indicator 324 can be rendered on the recording screen 304 or an indicator 324 in communication with system 100 such as a light emitting diode (LED) of a smart phone or camera.

In another aspect, the recording component 110 can automatically alter the project visualization element. The altering can be based on a user's history, a collection of users' histories, focusing of a camera, lighting, a type associated with a project and the like. As an example, a user can aim a media-capturing device at various different objects and/or adjust the focus of various different portions of a record screen. As the user adjusts the focus, the recording component 110 can automatically reposition, alter transparency of, or otherwise alter the project visualization element.

The editing component 116 can generate the editing screen 312. The editing screen 312 can display representations of media items of the project, a timeline, available actions, and the like. In another aspect, the editing component 116 can facilitate playback and/or preview of the project. As depicted, the editing screen 312 can render elements such as a saving element 328 for saving/publishing/sharing a project; an editing component 330 for editing media items of a project; and a sound element 332 for adding sound such as music to a project. It is noted that the editing component 116 can comprise additional elements and/or options related to editing.

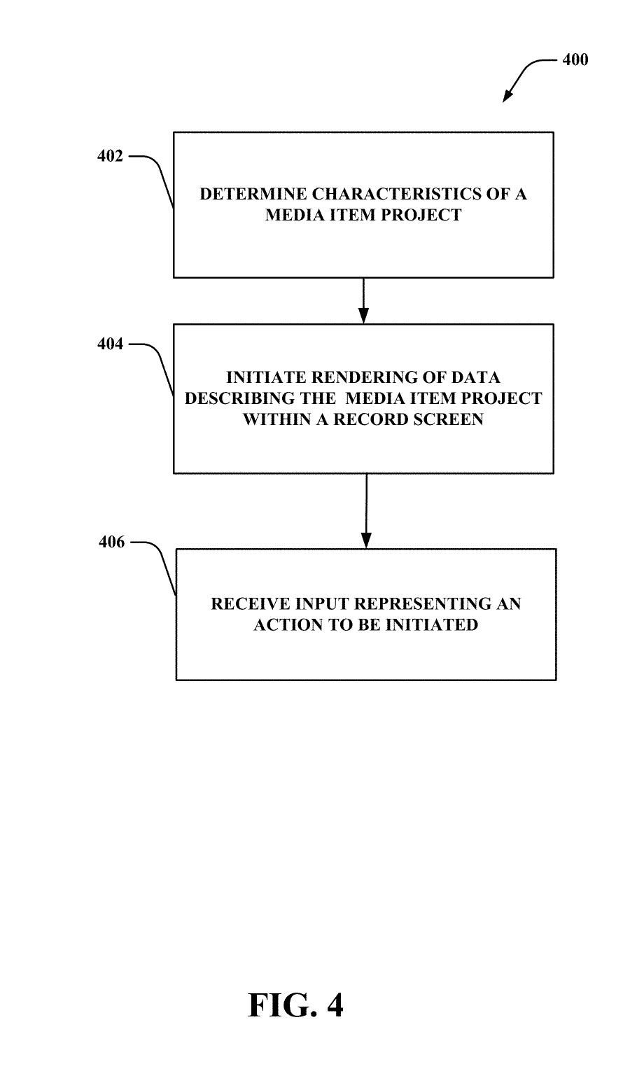

FIGS. 4-8 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. It is noted that a methodology can alternatively be represented as a series of interrelated states or events, such as in a state diagram. Moreover, not all illustrated acts may be required to implement a methodology in accordance with the disclosed subject matter. Additionally, it is to be further noted that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

With reference to FIG. 4, there is illustrated a methodology 400 for generating a visual representation of a media project during project generation, according to an aspect of this disclosure. As an example, various media applications, such as, but not limited to, systems 100 can 300, video capturing applications, audio capturing applications and the like, can use methodology 400. Specifically, methodology 400 renders a visual representation of a media item project within a record screen.

At 402, a system, comprising a computing device, can determine (e.g., via the container component 102) characteristics of a media item project. The characteristics can include total project length, media items of the project, creator, and the like. In an aspect, the characteristics can be comprised in stored data such as meta-data associated with the media item project, and the like.

At 404, the system can initiate rendering (e.g., via the portal component 106) of data describing the media item project within a record screen. For example, the system can render at least one of a thumbnail of a media item of the project, a total length of time of the project, and the like. It is noted that the data can be generated in a graphical representation such as an image, series of images, and the like. The record screen can comprise an output associated with an image capturing device. For example, the record screen can comprise a display of an image and/or set of images that corresponds to an image rendered by a camera.

At 406, the system can receive input representing an action to be initiated. As an example, a user can select a thumbnail to proceed to editing. In another aspect, a user can select an option to record a new media item, exit recording, save the project, and the like.

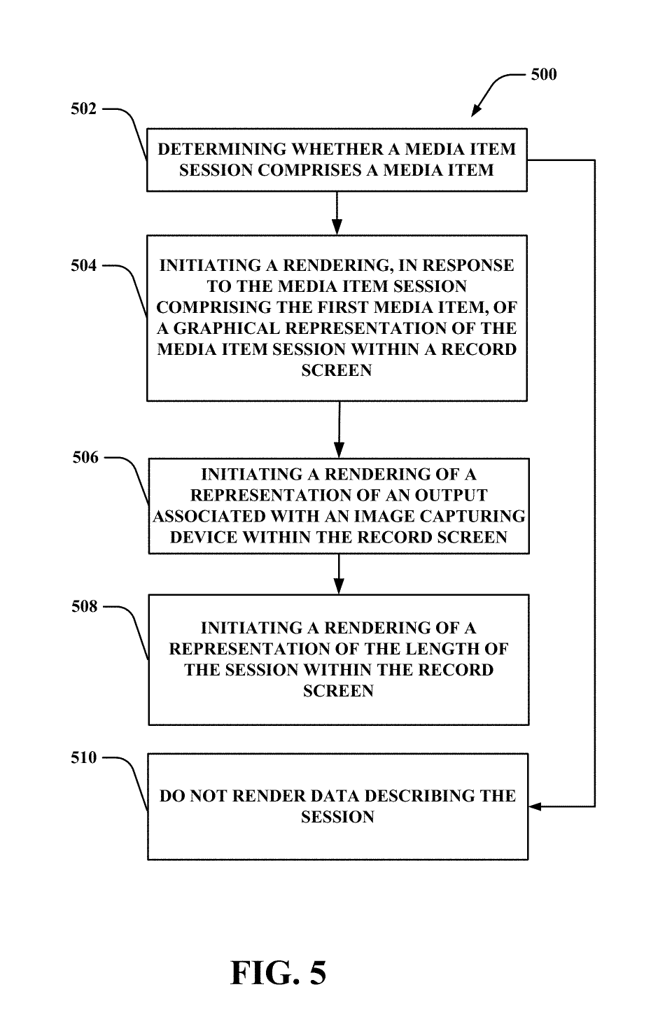

With reference to FIG. 5, there is illustrated a methodology 500 for generating a visual representation of a media project during project generation, according to an aspect of this disclosure. Specifically, methodology 500 determines whether to render a visual representation of a current project when within a recording screen.

At 502, a system can determine (e.g., via the container component 102) whether a media item session comprises a first media item. It is noted that a media item session and a media item project can both refer to a set of associated media items. At 504, a system can initiate a rendering (e.g., via the portal component 106), in response to the project comprising the media item, of a graphical representation of the media item session within a record screen. It is noted that the graphical representation of the media item session can comprise a thumbnail image of the media item or another media item comprised by the media item session, a set of images, a video clip(s), and the like. At 506, a system can initiate a rendering (e.g., via the portal component 106) of an output of associated with an image capturing device within the record screen. For example, the output can correspond to images perceived by a camera that are not currently being captured (e.g., recorded). At 508, the system can initiate (e.g., via the portal component 106) a rendering of a representation of the length of the project within the record screen. At 510, a system can determine (e.g., via the portal component 106) to not render, in response to determining that the media item session does not comprise a media item, data describing the project and/or to remove data describing the project from a screen. For example, in an active recording mode, the data can be removed to provide more screen space for the recording.

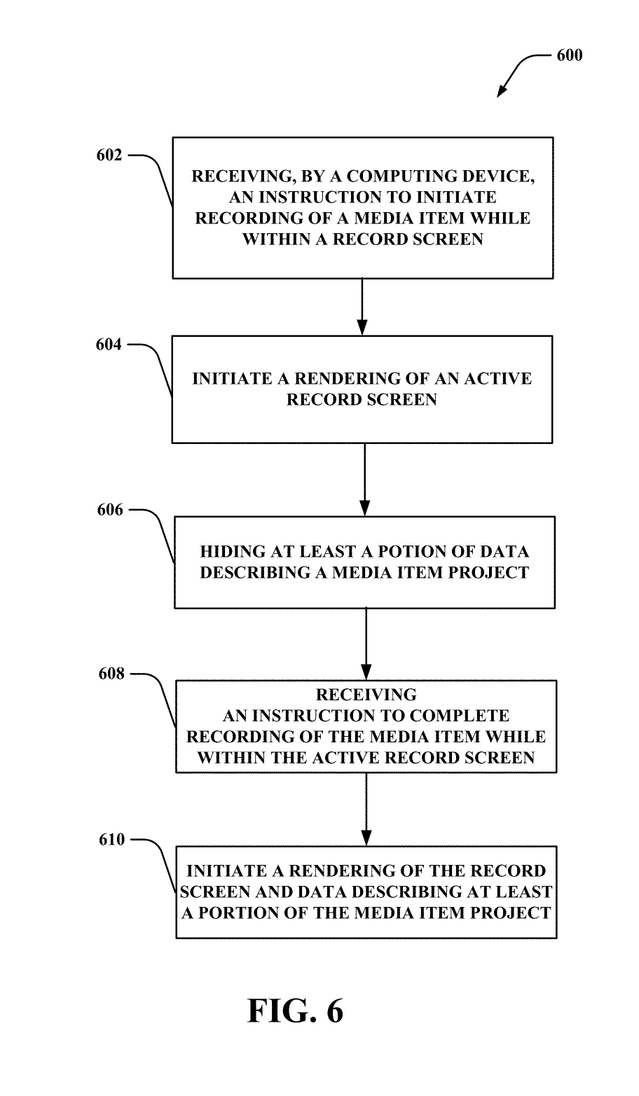

With reference to FIG. 6, there is illustrated a methodology 600 for generating a visual representation of a media project during project generation including removing at least a portion of the visual representation during an active recording mode, according to an aspect of this disclosure. At 602, a system, comprising a computing device, can receive an instruction to initiate recording of a media item while within a record screen. For example, a user can provide input to actuate a recording, via the recording component 110. In an aspect, a media-capturing device such as a camera, smart phone, or other device. It is noted that the media item can be stored and/or associated with a container via the container component 102.

At 604, the system can initiate a rendering (e.g., via recording component 110) of an active record screen. In an aspect, the active recording screen can comprise recording screens 304 and 308 for example. The active recording screen can comprise media as it is being captured. It is noted that active recording screen can render the media with a delay between capturing and the rendering.

At 606, the system can hide at least a portion of data describing a media item project. For example, during the active recording mode the system can disable and/or stop rendering a project visualization element such that a user can utilize a larger portion of the screen while capturing the media items.

At 608, the system can receive an instruction to complete recording of the media item while within the active record screen. For example, a user can actuate a button or other actuator to end the active recording.

At 610, the system can initiate a rendering of the record screen and data describing at least a portion of the media item project. In an aspect, the recording screen can comprise recording screens 302 and 306 for example.

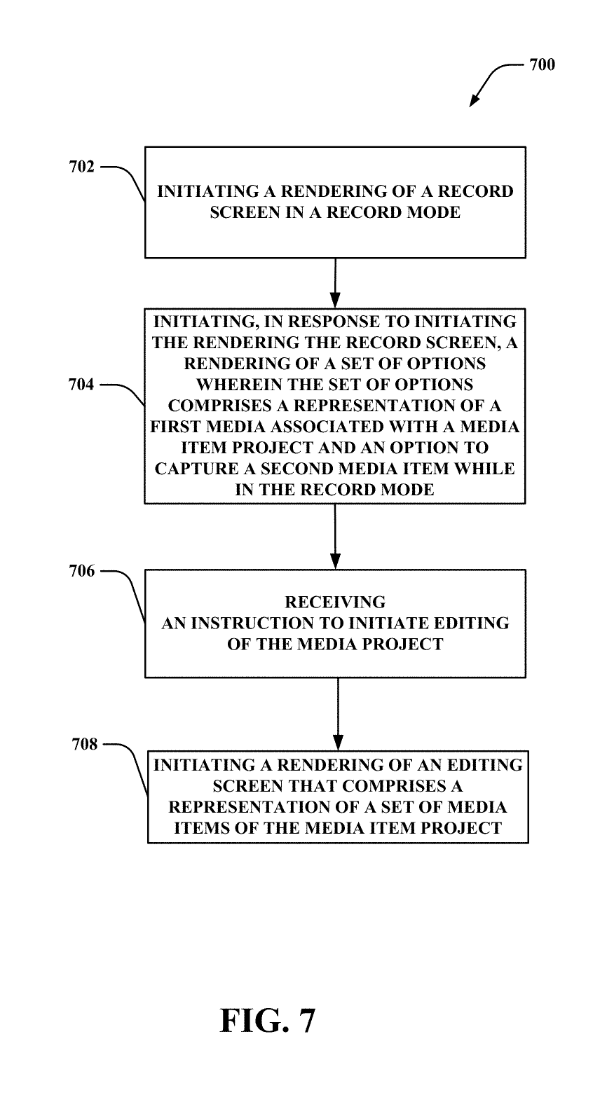

With reference to FIG. 7, there is illustrated a methodology 700 for generating a visual representation of a media project during project generation including rendering an editing screen in an editing mode, according to an aspect of this disclosure. At 702, a system comprising a computing device, (e.g., recording component 110, etc.), can initiate a rendering of a visual representation of a media item of a media project while within a record screen.

At 704, the system can initiate (via the portal component 106), in response to initiating the rendering the record screen, a rendering of a set of options wherein the set of options comprise a representation of a first media associated with and a media item project and an option to capture a second media item while in the record mode. For example, the system can render a display associated with a camera (e.g., media that has not yet been captured) and a thumbnail of media items of a media item session.

At 706, the system can receive an instruction to initiate editing of the media project. In an aspect, the instruction can be user input that indicates the user desires to edit the project. For example, the user select an option (e.g., on a recording screen) and/or an actuator on a larger system (e.g., a camera, smart phone, and the like). In another implementation, the user can select a project, from a list of projects, for editing in a different screen than the recording screen.

At 708, the system can initiate a rendering of an editing screen that comprises a representation of a set of media items of the media item project. For example, a user can select the visual representation of the media project in a recording screen and, in response, an editing component (e.g., editing component 116) can render an editing screen in an editing mode.

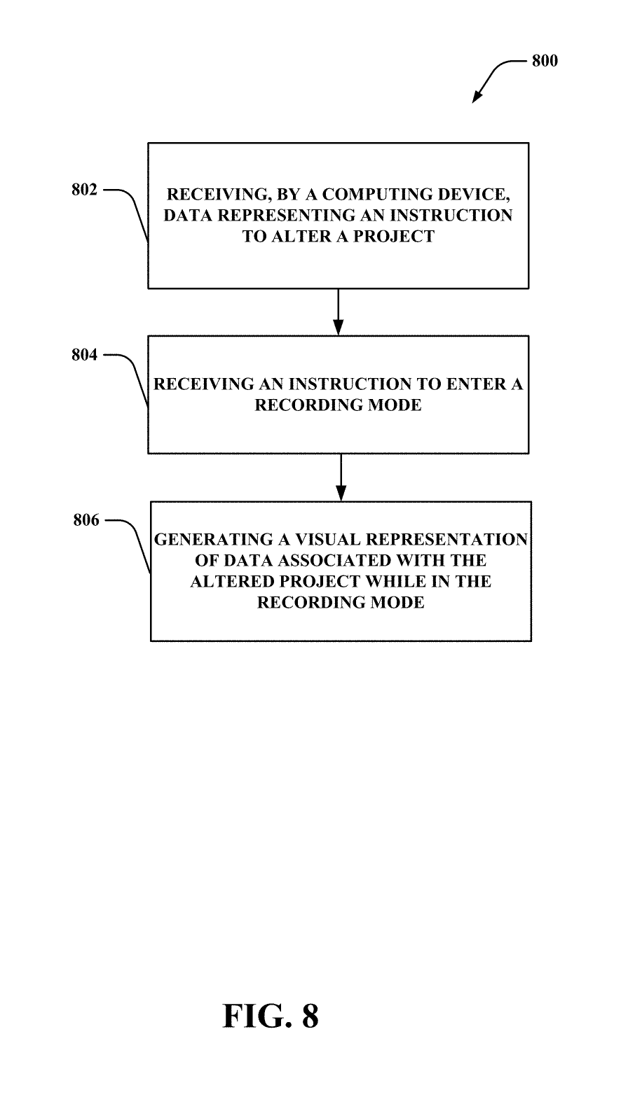

With reference to FIG. 8, there is illustrated a methodology 800 for generating a visual representation of a media project during project generation including updating at least a portion of the visual representation during a recording mode, according to an aspect of this disclosure.

At 802, a system, comprising a computing device, can receive (via the editing component 116) data representing an instruction to alter a project. The instruction can indicate that the user desires to discard, reorder, or otherwise alter the project. For example, the user can determine that a selected media item of a project does not meet a quality standard and can remove the media item. In another aspect, the user can determine to add another media item to the project.

At 804, the system can receive an instruction to enter a recording mode from the editing mode. In an aspect, the instruction can be associated with user input that represents a users desire to capture a new media item for the project.

At 806, the system can generate (e.g., via the portal component 106) a visual representation of data associated with the altered project while in the recording mode. For example, the visual representation can be a representation of a media item that is associated with the project. In one example, the portal component 106 can determine if a media item was deleted and/or selected for replacement. If the media item was deleted and/or select for replacement, the portal component can render a representation of the media item and can optionally render data indicated the media item is currently deleted and/or being replaced. In this manner the user can have a better understanding of the media item that is being deleted and/or replace. As another example, the system can receive an instruction to replace a media item at 804 and at 808; the system can generate the visual representation to indicate what media item is being replaced.

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

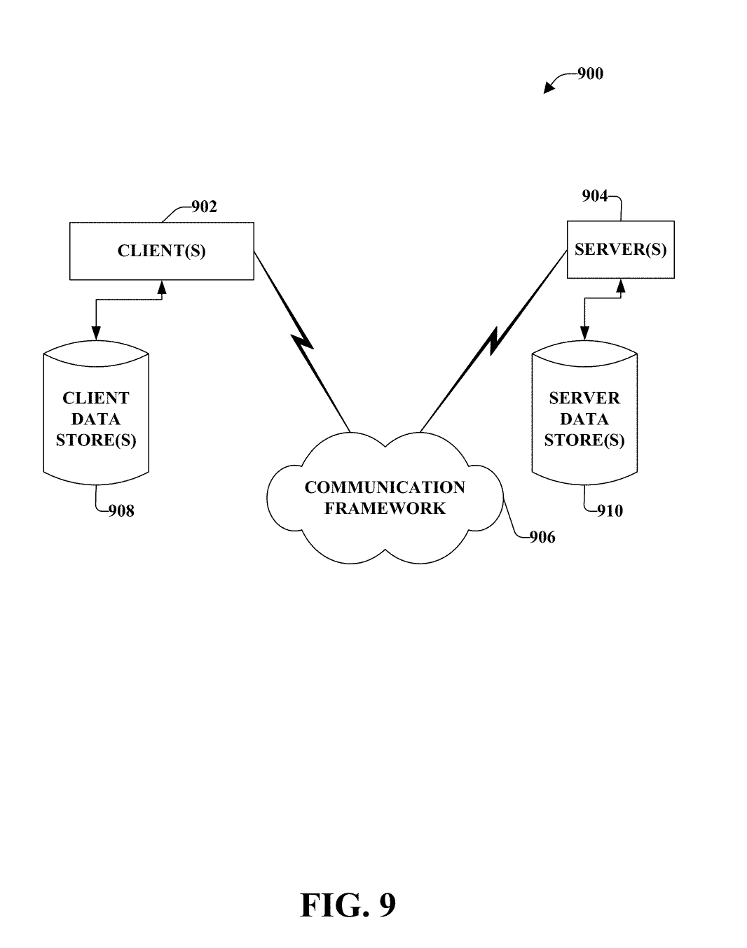

Referring now to FIG. 9, there is illustrated a schematic block diagram of a computing environment 900 in accordance with this specification. The system 900 includes one or more client(s) 902, (e.g., computers, smart phones, tablets, cameras, PDA's). The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware or hardware in combination with software (e.g., threads, processes, computing devices). The servers 904 can house threads to perform transformations by employing aspects of this disclosure, for example. One possible communication between a client 902 and a server 904 can be in the form of a data packet adapted to be transmitted between two or more computer processes wherein data packets may include coded campaigns and/or integrate campaigns. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

In one implementation, a client 902 can transfer an encoded file, (e.g., encoded campaigns), to server 904. Server 904 can store the file, decode the file, or transmit the file to another client 902. It is to be appreciated, that a client 902 can also transfer uncompressed file to a server 904 and server 904 can compress the file in accordance with the disclosed subject matter. Likewise, server 904 can encode video information and transmit the information via communication framework 906 to one or more clients 902.

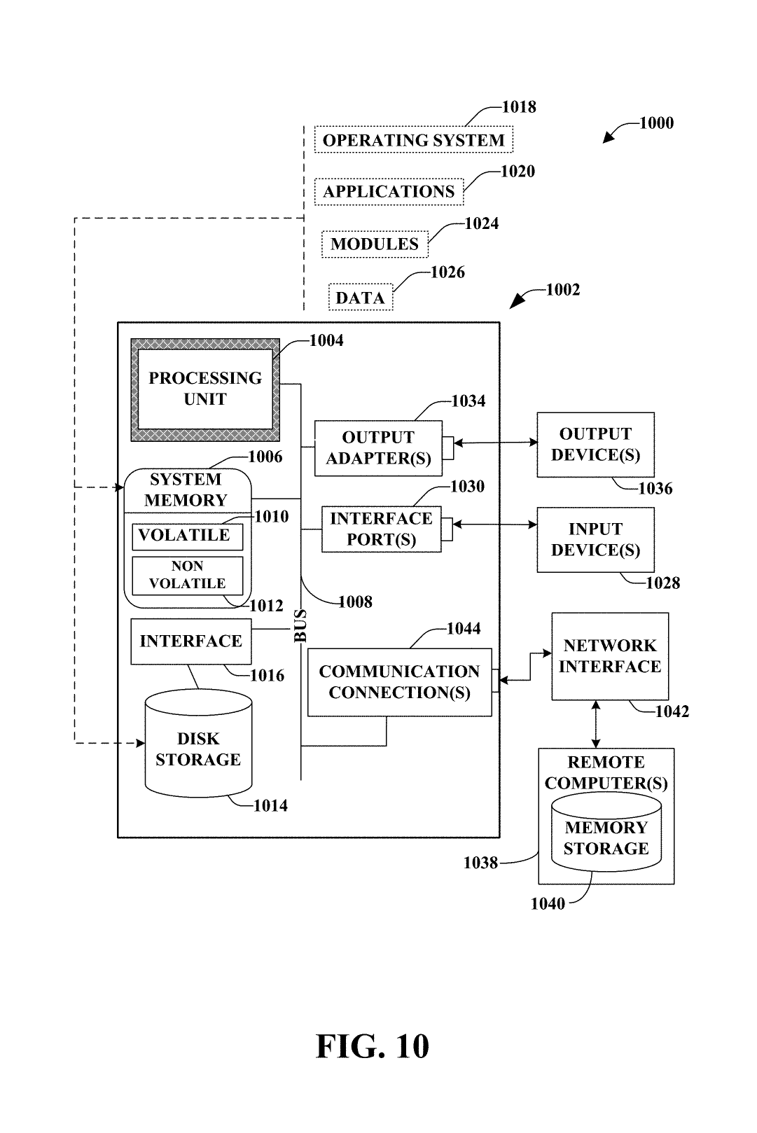

With reference to FIG. 10, a suitable environment 1000 for implementing various aspects of the claimed subject matter includes a computer 1002. The computer 1002 includes a processing unit 1004, a system memory 1006, a codec 1005, and a system bus 1008. The system bus 1008 couples system components including, but not limited to, the system memory 1006 to the processing unit 1004. The processing unit 1004 can be any of various available processors. Dual microprocessors and other multiprocessor architectures also can be employed as the processing unit 1004.

The system bus 1008 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire, and Small Computer Systems Interface (SCSI).

The system memory 1006 includes volatile memory 1010 and non-volatile memory 1012. The basic input/output system (BIOS), containing the basic routines to transfer information between elements within the computer 1002, such as during start-up, is stored in non-volatile memory 1012. By way of illustration, and not limitation, non-volatile memory 1012 can include read only memory (ROM), programmable ROM (PROM), electrically programmable ROM (EPROM), electrically erasable programmable ROM (EEPROM), or flash memory. Volatile memory 1010 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM).

Computer 1002 may also include removable/non-removable, volatile/non-volatile computer storage media. FIG. 10 illustrates, for example, a disk storage 1014. Disk storage 1014 includes, but is not limited to, devices like a magnetic disk drive, solid state disk (SSD) floppy disk drive, tape drive, Zip drive, LS-100 drive, flash memory card, or memory stick. In addition, disk storage 1014 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1014 to the system bus 1008, a removable or non-removable interface is typically used, such as interface 1016.

It is to be appreciated that FIG. 10 describes software, software in execution, hardware, and/or software in combination with hardware that acts as an intermediary between users and the basic computer resources described in the suitable operating environment 1000. Such software includes an operating system 1018. Operating system 1018, which can be stored on disk storage 1014, acts to control and allocate resources of the computer system 1002. Applications 1020 take advantage of the management of resources by operating system 1018 through program modules 1024, and program data 1026, such as the boot/shutdown transaction table and the like, stored either in system memory 1006 or on disk storage 1014. It is to be appreciated that the claimed subject matter can be implemented with various operating systems or combinations of operating systems. For example, applications 1020 and program data 1026 can include software implementing aspects of this disclosure.

A user enters commands or information into the computer 1002 through input device(s) 1028. Input devices 1028 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1004 through the system bus 1008 via interface port(s) 1030. Interface port(s) 1030 include, for example, a serial port, a parallel port, a game port, and a universal serial bus (USB). Output device(s) 1036 use some of the same type of ports as input device(s) 1028. Thus, for example, a USB port may be used to provide input to computer 1002, and to output information from computer 1002 to an output device 1036. Output adapter 1034 is provided to illustrate that there are some output devices 1036 like monitors, speakers, and printers, among other output devices 1036, which require special adapters. The output adapters 1034 include, by way of illustration and not limitation, video and sound cards that provide a means of connection between the output device 1036 and the system bus 1008. It should be noted that other devices and/or systems of devices provide both input and output capabilities such as remote computer(s) 1038.

Computer 1002 can operate in a networked environment using logical connections to one or more remote computers, such as remote computer(s) 1038. The remote computer(s) 1038 can be a personal computer, a server, a router, a network PC, a workstation, a microprocessor based appliance, a peer device, a smart phone, a tablet, or other network node, and typically includes many of the elements described relative to computer 1002. For purposes of brevity, only a memory storage device 1040 is illustrated with remote computer(s) 1038. Remote computer(s) 1038 is logically connected to computer 1002 through a network interface 1042 and then connected via communication connection(s) 1044. Network interface 1042 encompasses wire and/or wireless communication networks such as local-area networks (LAN), wide-area networks (WAN), and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1044 refers to the hardware/software employed to connect the network interface 1042 to the bus 1008. While communication connection 1044 is shown for illustrative clarity inside computer 1002, it can also be external to computer 1002. The hardware/software necessary for connection to the network interface 1042 includes, for exemplary purposes only, internal and external technologies such as, modems including regular telephone grade modems, cable modems and DSL modems, ISDN adapters, wired and wireless Ethernet cards, hubs, and routers.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing integration functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

1. A system comprising:
a memory; and
a processor, coupled to the memory, to:
receive a selection of a project from a plurality of projects;
determine whether the project comprises at least one media item;
display, within a recording user interface and in response to determining that the project comprises the at least one media item, a project indicator providing a visual representation of the project and a dynamic recording indicator, wherein the project indicator includes a thumbnail of a first media item that was previously captured, and the dynamic recording indicator indicates a recording state of a second media item, wherein the project indicator is not displayed for a project that does not include any media items;
responsive to completion of capturing the second media item, add a thumbnail of the second media item to the project indicator to indicate that the second media item has been added to the project;
calculate a project time based on a first length of time of the first media item and a second length of time of the second media item;
upon calculating the project time, display the project time in the project indicator;
determine whether a user selection of the project indicator comprises a first type of user input or a second type of user input;
in response to determining the user selection of the project indicator comprises the first type of user input, display an editing user interface to perform one or more actions with respect to any of the first media item or the second media item; and
in response to determining the user selection of the project indicator comprises the second type of user input, perform an action with respect to the project indicator in the recording user interface.

2. (canceled)

3. The system of claim 1, wherein, in response to the capturing of the second media item, the processor is further to:
add the second media item to the project; and
initiate rendering of a notification that signifies that the second media item is added to the project.

4. The system of claim 1, wherein the representation of the project comprises a slideshow or a composite thumbnail of the project.

5. The system of claim 1, wherein the representation includes at least one of a graphical representation of the first media item, a characteristic of the project, an option to exit a recording mode, or an option to initiate an editing mode.

6. The system of claim 1, wherein, in response to initiating the capturing of the second media item, the processor is to remove at least a portion of the representation of the project from the recording user interface during the capturing of the second media item.

7. The system of claim 1, wherein, in response to completing the capturing of the second media item, the processor is to incorporate the second media item into the representation of the project within the recording user interface.

8. The system of claim 1, wherein, in response to initiating the capturing of the second media item, the processor is to display, on the recording user interface, at least one of a total length of time of the project or a current length of time of the second media item.

9. The system of claim 1, wherein, in response to receiving input, the processor is to save the project as an unfinished project and exit the recording user interface.

10. The system of claim 1, wherein, in response to receiving input, the processor is to publish the project.

11. A method comprising:
receiving a selection of a media project from a plurality of projects;
upon receiving the selection of the media project, initiating, by a processor, a rendering of a record user interface in a record mode;
determining whether the media project comprises at least one media item;
in response to determining that the media project comprises the at least one media item, initiating a rendering of a set of interface elements within the recording user interface, wherein the set of interface elements comprises:
a project indicator providing a visual representation of the media project comprising a first media item, wherein the project indicator is not rendered for a media project that does not include any media items; and
a dynamic recording indicator to be selected to capture a second media item of the media project while in the record mode;
responsive to completion of capturing the second media item, updating the project indicator to indicate that the second media item has been added to the project;
calculating a project time based on a first length of time of the first media item and a second length of time of the second media item;
upon calculating the project time, displaying the project time in the project indicator;
determining whether a user selection of the project indicator comprises a first type of user input or a second type of user input;
in response to determining the user selection of the project indicator comprises the first type of user input, displaying an editing user interface to perform one or more actions with respect to any of the first media item or the second media item; and
in response to determining the user selection of the project indicator comprises the second type of user input, perform an action with respect to the project indicator in the recording user interface.

12. The method of claim 11, wherein the representation of the media project comprises a representation of the first media item and the second media item.

13. The method of claim 11, wherein the method further comprises:
initiating rendering of an editing user interface in an editing mode in response to selection of the representation of the media project.

14. The method of claim 11, wherein the representation of the media project is a composite thumbnail depiction of the first media item and the second media item.

15. The method of claim 11, wherein the representation of the media project is a selectable interface element and, in response to being selected, initiates an editing action.

16. The method of claim 11, wherein the representation of the media project is a slideshow depiction of the first media item and the second media item.

17. A computer readable storage medium comprising computer executable instructions that, in response to execution, cause a computing system comprising a processor to perform operations, comprising:
receiving a selection of a project from a plurality of projects;
determining whether the project comprises at least one media item;
in response to determining that the project comprises the at least one media item, initiating rendering of a set of interface elements on a recording user interface during an active record mode, wherein the set of interface elements comprises:
a project indicator providing a visual representation of a project comprising a first media item, wherein the project indicator is not rendered for a project that does not include any media items; and
a dynamic recording indicator to be selected to toggle the active record mode to capture a second media item;
responsive to completion of capturing the second media item, updating the project indicator to indicate that the second media item has been added to the project;
calculating a project time based on a first length of time of the first media item and a second length of time of the second media item;
upon calculating the project time, displaying the project time in the project indicator;
determining whether a user selection of the project indicator comprises a first type of user input or a second type of user input; and
in response to determining a user selection of the project indicator comprises the first type of user input, displaying an editing user interface to perform one or more actions with respect to any of the first media item or the second media item; and
in response to determining the user selection of the project indicator comprises the second type of user input, perform an action with respect to the project indicator in the recording user interface.

18. The computer readable storage medium of claim 17, further comprising:
rendering a graphical representation of the project comprising a set of media items associated with the project to be aggregated.

19. The computer readable storage medium of claim 17, wherein the graphical representation of the project is a summary of at least one media item associated with the project.

20. The computer readable storage medium of claim 19, wherein the at least one media item comprises a captured media item from an image capturing device or a stored media item stored in a memory store.
